(19) United States
(12) Patent Application Publication
(10) Pub. No.: US 2006/0272909 A1
(43) Pub. Date: Dec. 7, 2006

(54) Brake assembly and coating

(76) Inventors: Brian K. Fuller, Rochester Hills, MI (US); John R. Smith, Birmingham, MI (US); Zhibo Zhao, Novi, MI (US); Bryan A. Gillispie, Macomb Twp., MI (US); Kwok K. Wan, Rochester, MI (US); Eric W. Jasme, Swartz Creek, MI (US); Alaa A. Elmoursi, Troy, MI (US); Nilesh B. Patel, Macomb Twp., MI (US)

Correspondence Address: DELPHI TECHNOLOGIES, INC., M/C 480-410-202, PO BOX 5052, TROY, MI, 48007, US

(21) Appl. No.: 11/143,692

(22) Filed: Jun. 2, 2005

(51) Int. Cl. F16D 69/00

(52) U.S. Cl. 188/251 A

(57) ABSTRACT

A brake assembly is provided that includes a wear-resistant surface, or a surface prone to corrosion, wherein the surface is coated with a coating that optimizes wear-resistance, corrosion-resistance, adhesiveness, and friction factors of the coating. The coating includes a sacrificial corrosion constituent and a second constituent that is relatively harder than the sacrificial corrosion constituent wherein typical metals often employed as sacrificial anodes for example are contemplated. These include aluminum, zinc, and alloys thereof. The second constituent is potentially formed from a carbide, nitride, oxide, transitional metals and alloys thereof, and mixtures thereof.

### FIELD OF THE INVENTION

The present invention relates to coatings applied to metallic surfaces that typically are exposed to conditions that promote corrosion and surface wear. The application of the coatings provides sacrificial corrosion protection to the metallic surface and provides temporary wear resistance for longer periods of time than present day purely sacrificial corrosion resistant coatings.

### BACKGROUND OF THE INVENTION

Many maritime, aeronautical, or automotive components that are typically exposed to corrosive environments employ protective coatings to prevent or at least mitigate the likelihood of corrosion. An ongoing challenge with regard to these coatings is to ensure continued corrosion protection in the presence of other applied stresses, those typically found in high-wear environments for example.

In general, such a coating is applied in the form of an adhesive coating(s) over a surface. An exemplary surface would be a wear surface on a rotor, wherein a brake shoe or lining periodically interfaces with the surface during brake operation, thereby resulting in wear of the surface. Adequate coating adhesion and thermal stability is required to resist debonding during operation. For example, it may be desirable to apply such a temporary wear and corrosion resistant coating over brake rotors and drums. The coating should not spall, but should wear away evenly over time without offering an abrupt change of output torque. Coatings such as these would provide alternatives to known sprayed and dried paints that often possess limited on-vehicle performance longevity.

Although affective to reduce corrosion, sacrificial corrosion protection coatings by themselves may not be suited to wear applications. For example, concerns have been identified when these coatings were used in an automotive braking application. To illustrate, when a zinc corrosion resistant coating is applied over an automotive front brake rotor, the standard brake lining comes into sliding contact with the coating. The coating is found to exhibit galling and/or the build-up of asperities (regions of accumulated material, high spots) over the wear surface that interferes with braking action. Asperities can induce unwanted vibration and audible noise from the braking system. Furthermore, these asperities can erode the surface of the brake lining as the number of revolutions of the rotor past the stationary lining increases

Yet another concern involves the volatile organic compounds that are often attendant to the application of paints to the surface of components such as those usually found in automotive brake assemblies.

Accordingly, it would be an improvement in the art to form a coating that prevents both the formation of asperities on the coating, and material build up on the lining, while maintaining the use of soft sacrificially corrosion resistant material like zinc, zinc/aluminum alloy, zinc/nickel alloy, aluminum, aluminum alloy, or any other preferred sacrificially corrosion material. Although the present emphasis is placed on cast iron surfaces and vehicle braking applications, other base materials and/or other high wear applications for example, are also contemplated within the present invention.

### SUMMARY

In accordance with the present invention, a brake assembly having at least one surface predisposed to corrosion is provided, wherein the subject surface(s) is coated to mitigate the likelihood of corrosion while concurrently maintaining torque and wear requirements. In practice, many brake assemblies may have more than one surface requiring corrosion protection. Nevertheless, the present coatings additionally provide wear protection and an average friction coefficient that result in substantially improved protection for surfaces typically exposed to relatively high pressure, temperature, and friction as compared to the rest of the brake assembly. In particular, surface areas that interface with brake shoes or brake linings for example are subject to heat and wear every time the brake pedal is pushed and pressure is exerted along a respective area of the rotor or disc. Furthermore, with regard to drum brakes, the inner shoes also wear against an inner wall of the drum every time the brakes are actuated.

Stated another way, the present invention involves a coating, or family of composite coatings, needed to produce a temporary corrosion and wear resistant adhesive coating over a substrate. In accordance with the present invention, the concept of combining both sacrificial corrosion materials with wear tolerant materials over surfaces in friction applications results in an improvement where both corrosion and wear tolerance are of concern. Additionally, these coatings may be required to provide adequate frictional performance to stop, and repeatedly stop a moving vehicle. Such a coating, a particular combination of corrosion and wear resistant materials, a composite, an alloy, or mixture of materials, is applied in the form of an adhesive coating(s) over a wear surface. With the proper choice of coating constituent materials and the applied thickness of the coating, the wear, friction coefficient, and sacrificial corrosion resistance of the coating may be controlled.

### IN THE DRAWINGS

FIG. 1 is a vertical cross-sectional view taken through a first illustrative brake system;

FIG. 2 is a view of a portion of the first illustrative brake system taken in the direction of the arrow II in FIG. 1;

FIG. 3 is a view of a further portion of the first illustrative brake system taken in the direction of the arrow III in FIG. 1;

FIG. 4 is an exploded view of a second illustrative brake system;

FIG. 5 is a side view of an exemplary drum brake assembly illustrating a brake shoe assembly in operative relationship to a brake drum surface; and

FIG. 6 illustrates an exemplary spray process for application of a coating to a brake rotor, in accordance with the present invention.

### DETAILED DESCRIPTION OF THE PRESENT INVENTION

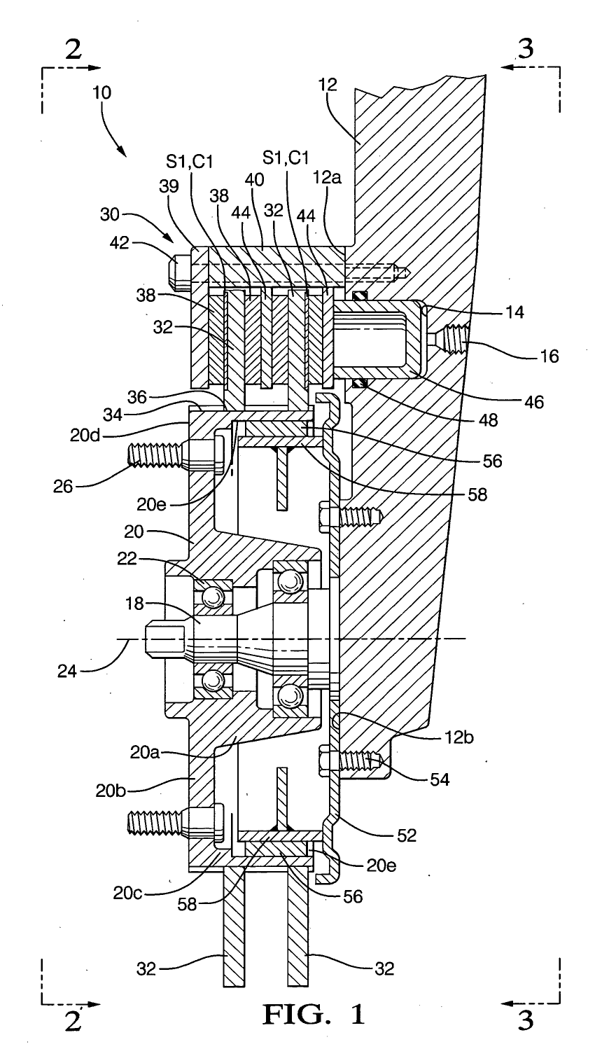

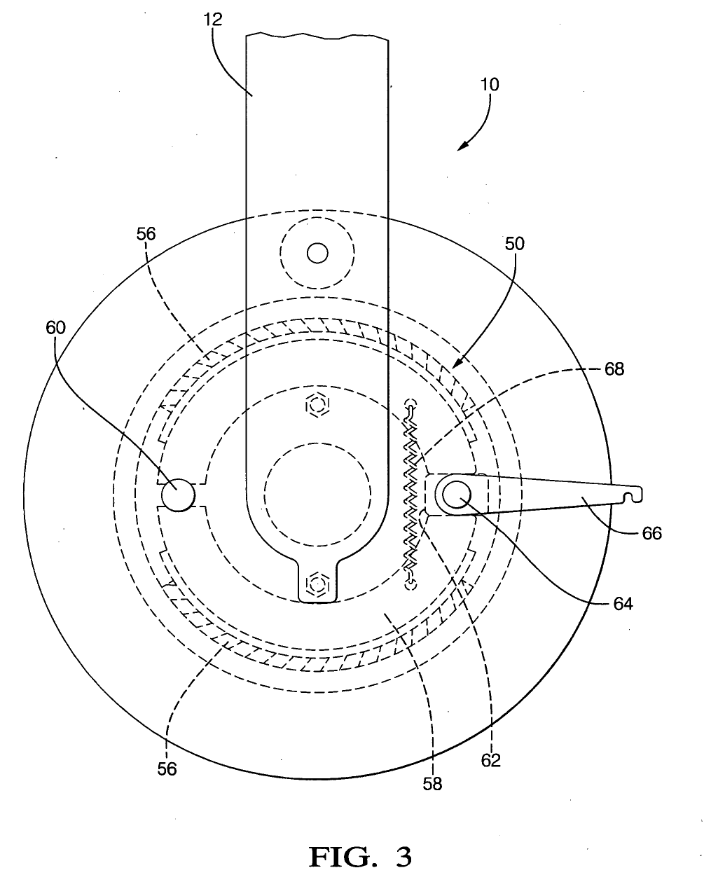

The illustrative brake system 10 shown in FIGS. 1-3 is mounted on a suspension link 12 of a vehicle. On one side thereof, the link 12 has an upper vertical mounting surface 12a and a lower vertical mounting surface 12b (see FIG. 1). A cylindrical recess 14 is formed in the link 12 and has an opening through the surface 12a. The recess 14 has a connection between its bottom surface and a connecting point 16 in the link 12 for a hydraulic pipe (not shown) so that hydraulic fluid under pressure can be delivered to the recess 14 so that (as further described below) the recess 14 can be utilized as the cylinder of a hydraulically-operated piston and cylinder assembly of a disc brake of the system 10. The link 12 also supports a stub axle 18 which extends horizontally from the lower mounting surface 12b.

The illustrative brake system 10 also comprises a hub 20 which is mounted on the stub axle 18 on bearings 22. The hub 20 is mounted for rotation about a central horizontal axis 24 thereof. The hub 20 comprises a central portion 20a which houses the bearings 22, an annular flange portion 20b which extends vertically at one end of the portion 20a, and a mounting portion 20c generally having the shape of a hollow cylinder centered on the axis 24. The flange portion 20b provides an annular vertical mounting surface 20d to which a wheel (not shown) can be bolted by bolts 26 in a conventional manner. The mounting portion 20c is joined to an outer peripheral portion of the flange portion 20b and extends around the central portion 20a.

The illustrative brake system 10 also comprises a disc brake 30 which is generally of the type disclosed in WO 98/25804. The brake 30 comprises two discs 32 which are in the form of annular plates formed of steel. The discs 32 are mounted on the outer surface of mounting portion 20c of the hub 20 so that the discs 32 rotate with the hub 20 about the axis 24 and so that the discs 32 can perform axial sliding movement on the hub 20. Specifically, grooves 34 are formed in the external surface of the mounting portion 20c, each groove 34 extending parallel to the axis 24, and teeth 36 project from the discs 32 into the grooves 34. The teeth 36 serve to transmit rotational forces between the discs 32 and the hub 20 and can slide axially along the grooves 34. As disclosed in WO 98/25804, leaf springs (not shown) provide resilient means acting between the hub 20 and the discs 32 to apply radial force to control the movement of the discs 32.

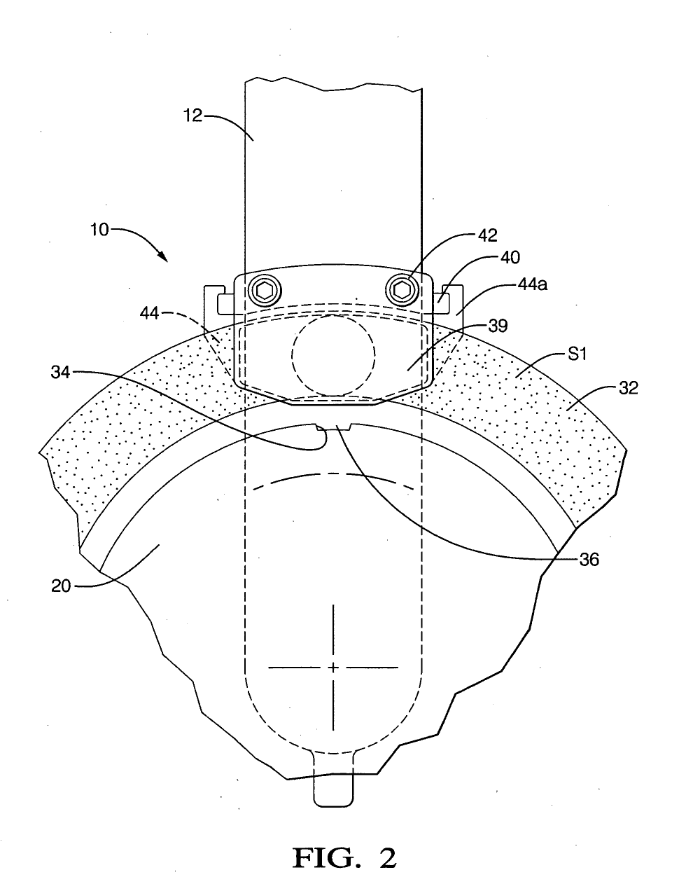

The disc brake 30 also comprises friction material pads 38 which are mounted on both sides of each of the discs 32. There are four pads 38, these being an outer pad 38 which is mounted on an abutment 39 which is fixed relative to the link 12, two central pads 38 which are between the discs 32 and are mounted for axial movement, and an inner pad 38 (closest to the link 12) which is also mounted for axial movement. Specifically, a caliper 40 is secured to the mounting surface 12a of the link 12 by two bolts 42. The abutment 39 is secured to the caliper 40 by the bolts 42 and the central and inner pads 38 are mounted on supports 44 which are slidable on the outside surfaces of the caliper 40, the central pads 38 being mounted on opposite surfaces of the same support 44. Specifically, the supports 44 have hook-like projections 44a (see FIG. 2) which hook over side surfaces of the caliper 40 which, thus, provides a slideway extending axially.

The disc brake 30 also comprises an operating mechanism operable to bring the pads 38 into contact with the opposite surfaces of the discs 32 so that braking force is applied to the discs 32. The operating mechanism is provided by the aforementioned piston and cylinder assembly which comprises a piston 46 mounted in the recess 14 of the link 12, the recess 14 providing the cylinder of the assembly. The assembly also comprises a sealing ring 48 mounted in a groove in the wall of the recess 14 and engaging the outer surface of the piston 46. When hydraulic fluid under pressure is applied to the connection point 16, the piston 46 is urged out of the recess 14. The piston 46 engages the support 44 of the inner pad 38 and moves it along the caliper 40. The inner pad 38 then engages one of the discs 32 causing it to slide on the hub 20. This disc 32 then engages one of the central pads 38, causing the support 44 of both central pads 38 to move along the caliper 40. The other central pad 38 then engages the other disc 32 and moves it on the hub 20. This disc 32 then engages the fixed outer pad 38 when each disc is actuated.

The illustrative brake system 10 also comprises a drum brake 50 arranged to serve as a parking brake to prevent rotation of the hub 20 when the brake 50 is applied. The drum brake 50 comprises a supporting plate 52 which is bolted to the mounting surface 12b of the link 12 by bolts 54, the plate 52 having a central hole through which the stub axle 18 passes. The drum brake 50 is positioned in the space between the portion 20a of the hub 20 and the internal cylindrical surface 20e of the mounting portion 20c of the hub 20. The drum brake 50 comprises two friction material shoes 56 which are arcuate having convex surfaces which face the surface 20e of the mounting portion 20c. The shoes 56 are mounted on arcuate supports 58 which are pivotal at one end thereof on a horizontal pin 60 supported by the plate 52. The other end of each of the supports 58 engages a cam 62 which is arranged to be turned about a horizontal pin 64 by operation of a lever 66. The pin 64 is supported by the plate 52 and the lever 66 projects through a space between the plate 52 and the mounting portion 20c of the hub 20. The supports 58 are arranged so that they leave sufficient space between them for the portion 20a of the hub 20. The cam 62 has a shorter radial extent which engages the supports 58 when the drum brake 50 is in an inoperative condition but, by operation of the lever 66, can be turned into an operative condition in which a larger radial extent of the cam 62 engages the supports 58. A spring 68 acts between the supports 58 to keep them in contact with the cam 62. In moving from the inoperative condition to the operative condition thereof, the cam 62 pivots the supports 58 about the pin 60, thereby moving the shoes 56 apart and into engagement with the surface 20e of the mounting portion 20c of the hub 20 so that the drum brake 50 acts as a parking brake.

As shown in FIG. 1, a surface S1 engages or interfaces with a mating surface(s) of the calipers or brake shoes upon activation of the brakes. The system is described in co-owned U.S. Pat. No. 6,484,852, herein incorporated by reference. It will be appreciated that each time the brake system is activated, the surface S1 is slightly worn thereby subjecting the surface to corrosion if not properly protected. In accordance with the present invention, a first coating C1 may be applied over the surface S1 as described herein, thereby protecting the resultant underlying surface S1.

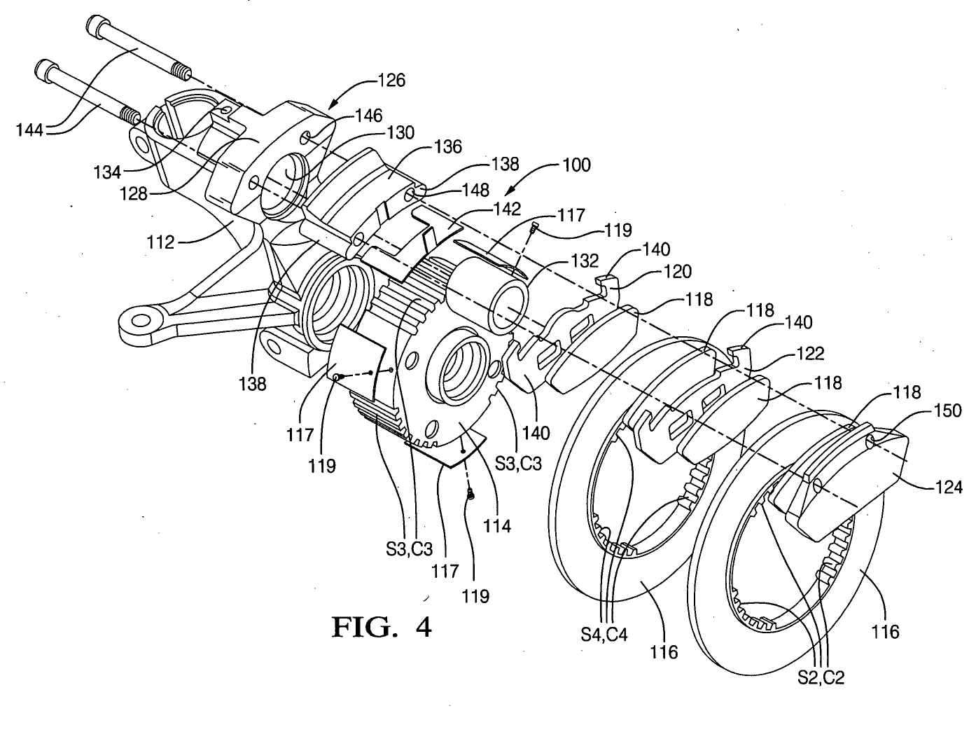

Yet another exemplary brake system is illustrated in FIG. 4. As described in U.S. Pat. No. 6,298,953, herein incorporated by reference, the illustrative disc brake 100 is mounted on a suspension link 112 of a vehicle. The suspension link 112 has a hub 114 mounted for rotation thereon. A wheel (not shown) is mounted on the hub in the usual manner. The brake 100 also comprises two discs 116 which are mounted on the hub 114 for axial sliding movement. Specifically, the outer surface of the hub 114 has three circumferentially-spaced surface portions which are formed with axial splines and the discs 116 are formed with teeth which mesh with these splines so that the discs can slide axially on the hub but rotate therewith. The hub 114 has three leaf springs 117 secured thereto by screws 119. The leaf springs 117 are arranged on the surface portions of the hub between the splines thereof and serve to centralize the discs 116 and to prevent them from rattling on the hub.

The brake 100 also comprises friction material pads 118 arranged on opposite sides of each of the discs 116. Specifically, one of the friction pads 118 is mounted on a backing plate 120 on one side of a first of the discs 116, two of the pads 118 are mounted on opposite sides of a backing plate 122 which is between the first and the second discs 116, and one of the pads 118 is mounted on an abutment 124 on an opposite side of the second disc 116 to the backing plate 122.

The brake 10 also comprises an operating mechanism 126 operable to move the pad 118 on the backing plate 120 into contact with the first disc 116. The mechanism 126 is also affective to cause relative movement between the mechanism 126 and the discs 116 to bring the other pads 118 mounted on the backing plate 122 and the abutment 124 into contact with the discs so that the pads all apply a braking force to the discs. Specifically, movement of the pad 118 on the backing plate 120 into contact with the first disc 116 causes the first disc 116 to slide on the hub 114 into contact with one of the pads 118 on the backing plate 122, continued movement brings the other pad 118 on the backing plate 122 into contact with the second disc 116 which, in turn, slides on the hub 114 until the second disc 116 contacts the pad 118 on the abutment 124.

The operating mechanism 126 comprises a support body 128 which is located on one side of the first disc 116. The support body 128 is provided by a portion of the link 112. The operating mechanism 126 also comprises a cylinder 130 defined by the support body 128, and a piston 132 in the cylinder. The piston 132 is movable, when fluid under pressure is introduced into the cylinder 130 through a port 134 to move out of the cylinder and thereby urge the backing plate 120 and the pad 118 mounted thereon towards the first disc 118.

The operating mechanism 126 also comprises a guidance member 136 projecting from the support body 128 past the discs 116. The guidance member 136 supports the abutment 124. The backing plates 120 and 122 and the pads mounted thereon are mounted for sliding movement on the guidance member 136. Specifically, the guidance member 136 has two arcuate side surfaces 138 on which the plates 120 and 122 slide. The plates 120 and 122 having upper hook portions 140 which hook over the surfaces 138 so that the plates 120 and 122 are supported by the member 136 and can slide along the member 136. A leaf spring 142 is provided between the underside of the member 136 and the plates 120 and 122, the spring 142 serving to prevent rattling.

The guidance member 136 of the operating mechanism 126 is mounted on the support body 128 by means of a two high tensile bolts 144 which pass through bores 146 in the support body 128 and bores 148 in the guidance member 136 to enter threaded bores 150 in the abutment 124.

In the operating mechanism 126, introduction of hydraulic fluid under pressure into the cylinder 130 causes the piston 132 to urge the pads 118 into contact with the discs 116 as aforementioned. When this contact has been achieved braking forces between each of the pads 118 and the discs 116 are transmitted to the member 136 via the backing plates 120 and 122 and the abutment 124. However, the high bending and shearing forces applied thereby to the guidance member 136 is taken by the bolts 144.

As shown in FIG. 4, and in accordance with the present invention, a toothed surface S2 is formed on an inner annular wall of a rotor for axial placement upon and mating with a complementary surface S3 on a wheel hub. The hub thereby provides rotary movement to the rotor until the rotor engages or interfaces with a mating surface(s) of the calipers or brake shoes upon activation of the brakes. It will be appreciated that given the stress imparted to surfaces S2 and S3, not only during operation, but also due to formation of the intricate shapes shown, corrosion may typically occur along the interface of S2 and S3. A fourth surface S4 may be coated as well and interfaces with a complementary set of brake shoes or liners. It will be appreciated that each time the brake system is activated, the surface S4 is slightly worn thereby subjecting the surface to corrosion if not properly protected. Accordingly, coatings C2, C3, and C4 are applied as described herein thereby providing corrosion and wear resistant protection to the underlying respective surfaces S2, S3, and S4.

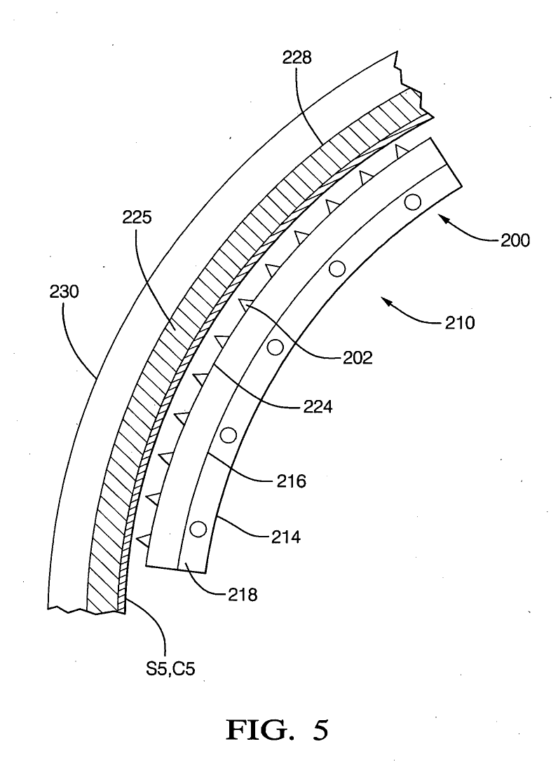

FIG. 5 is yet another exemplary brake assembly that incorporates a drum and inner arcuate shoe(s), as described in U.S. Pat. No. 6,860,368, herein incorporated by reference. It should be noted that other brake assemblies are also contemplated in accordance with the present invention and include, but not by way of limitation, those described in U.S. Pat. Nos. 6,640,937, 6,508,338, and 6,508,340, herein incorporated by reference. During operation of a vehicle braking system, the brake shoe assembly 200 is actuated in a conventional manner to move the outer friction surface 224 and projecting extensions 202 into contact with an opposing friction surface 226, if present on an inner cylindrical surface 228 of a co-axially mounted brake drum 230, or directly against the inner cylindrical surface 228.

Operation of the vehicle braking system when the vehicle is in motion, i.e. application of an emergency brake, results in the outer friction surface 224 and projecting extensions 202 being moved into rotational or sliding contact with the opposing friction surface 226. This results in a dynamic frictional force at the contacting friction surfaces and projecting extensions 202, acting to reduce the relative rotation between the brake drum 230 and the brake shoe assembly 200.

As shown in FIG. 5, a fifth surface S5 of the brake drum engages or interfaces with a mating surface of the brake shoes upon activation of the brakes. It will be appreciated that each time the brake system is activated, the surface S5 is slightly worn thereby subjecting the surface to corrosion if not properly protected. As also shown in FIG. 5, a sixth surface S6 of the brake shoe interfaces with an inner annular face of the drum and may also be eroded over time thereby causing corrosion on the brake shoe. Accordingly, in accordance with the present invention, coating C5 may if desired, be applied to respective surface S5 thereby protecting the resultant underlying surfaces.

Accordingly, the components of the brake assembly may be fabricated in a known manner from standard gray cast iron, steel, aluminum, or other material, alloy, or composite. Brake component applications include rotors, drums, disc brake pads, and other surfaces that experience sliding frictional motion.

In accordance with the present invention, a coating is applied to a component, a brake assembly component for example, wherein the assembly includes at least one wear surface having a propensity or likelihood of corroding, or to at least one surface predisposed to corrosion. The coating includes a sacrificial corrosion constituent, and, a relatively hard component selected from a group including diamond, carbides, nitrides, transitional metals and alloys thereof, and other materials having similar properties and similar hardness. The coatings of the present invention improve on the adhesiveness and wear resistance of the coating as compared to the typically applied coatings of paint as a corrosion resistant coating that simply possesses limited on-vehicle performance longevity.

The sacrificial corrosion component is chosen with regard to the electrode potential of the metallic or brake component the coating is applied to. Stated another way, the rotor or disc or drum (brake component) is electropositive relative to the coating, or, the coating is electronegative relative to the brake component. To illustrate, as recognized in standard metallurgy, a suitable sacrificial corrosion component for a cast iron rotor would include zinc, magnesium, magnesium alloy, aluminum, aluminum alloy, or a zinc/aluminum alloy. On the other hand, a suitable sacrificial corrosion component for an aluminum rotor would include magnesium. Accordingly, the electrode potential of the metal or alloy employed to form the brake component(s) will determine the sacrificial corrosion component of the coating, or, the electrode potential of the rotor will be greater or more positive than the more negative electrode potential of the sacrificial corrosion component. It will be appreciated that the electrode potential is determined relative to the standard hydrogen electrode as recognized in the art. The Principles of Materials Science and Engineering, pages 646-649, 1986 McGraw-Hill, Inc. describes these known principles and is incorporated herein by reference. The efficacy of the sacrificial corrosion component may be determined by testing defined by ASTM B117, and iteratively adjusted based on design requirements. The sacrificial corrosion component may be applied by weight at about 30 to 90% of the total coating.

The relatively hard or wear-resistant component is dispersed within the sacrificial corrosion constituent and is selected from carbides, nitrides, oxides, quasicrystals including Al—Fe—Cu and Al—Mn—Cu, transitional metals and alloys thereof, mixtures thereof, and other materials exhibiting similar properties and hardness. Carbides include silicon carbide, transitional metal carbides, chromium carbide, tungsten carbide, boron carbide, other carbides, and mixtures thereof. Nitrides include silicon nitride, boron nitride, titanium nitride, chromium nitride, other nitrides, and mixtures thereof. Oxides include aluminum oxide, chromium oxide, iron oxides, titanium dioxide, other relatively hard oxides, and mixtures thereof. Transitional metals and alloys thereof include, but are not limited to, copper, 420 stainless steel, other stainless steels, copper alloys, nickel alloys, brass, silicon bronze, other bronzes, chromium, and cobalt. It will be appreciated that the frictional behavior of the coating, or the coefficient of friction, will vary with regard to the type, shape, and quantity of the hard component. Accordingly, the frictional behavior may be measured in a known manner, by a dynamometer and resultant torque readings, for example, and then iteratively adjusted depending on design requirements. The second constituent or “hard” constituent may be provided by weight at about 10-70% of the total coating.

Exemplary hardness of various materials incorporated in the present coatings are tabulated in the table given below.

| Material | Hardness of Wire (Knoop) | Hardness of Coating (Knoop) |
|---|---|---|
| Zn | 48 | 41 |
| ZnAl | 38 | 70 |
| Cu | 192 | 205 |
| AlSi | 84 | 86 |

Accordingly, the hardness of the hard constituents of the present invention may be exemplified by the data given above. Or, stated another way, the hardness of the constituents may range for example from 84 to 192. The resultant hardness of the coatings may in turn range for example from 86 to 205. In general, the second constituent should impart a greater hardness to the coating than what is provided by the sacrificial corrosion constituent alone.

The coating is applied by one or more of a number of known methods. A thermal arc spraying process, a kinetic spraying and agglomeration process, a combustion wire thermal spray process, and other application techniques with or without post-processing that result in an adherent composite coating are contemplated in accordance with the present invention. Various processes are described at www.gordonengland.co.uk, the discussions of which are herein incorporated by reference. The thickness range of the coating is preferably from 0.5 to about 3.0 mils, although it may be greater given that the spraying capability of thermal spray is about 40 mils, and that of kinetic spray is several centimeters. Accordingly, when dual wires are employed for example, that is different wires sprayed by a single gun, the diameter of the wire size may be drawn down and adjusted for the desired composition of the coating. To illustrate, 420SS 1.6 mm was drawn down to 1.4 mm to reduce SS composition from 40 to 30%. When two guns are employed, each independently spraying a different material, then the composition may be controlled by the wire feed rate. For example, the TAFA 8835 gun can provide wire feed between 500-1400 analog readout that correlates to a current of about 50-300 amperes. The greater the current, the greater the deposition rate. For kinetic spray, the coating composition is controlled by the percentage of the constituents in the feedstock powder. Adequate coating adhesion is required to resist debonding during operation. For example, it may be desirable to apply such a temporary wear and corrosion resistant coating over brake rotors and drums. The coating should not spall, but should wear away evenly over time without offering an abrupt change of output torque.

Stated another way, the coating will be applied with attention to deposition parameters, coating composition, and substrate preparation. Pre- or post deposition treatments may be desired to alter the ultimate film or surface characteristics, or to improve bonding/adhesion between the coating and the substrate. The coating composition may be tailored to offer a desired coefficient of friction over a range of loads, temperatures, and conditions, wet and dry roads for example.

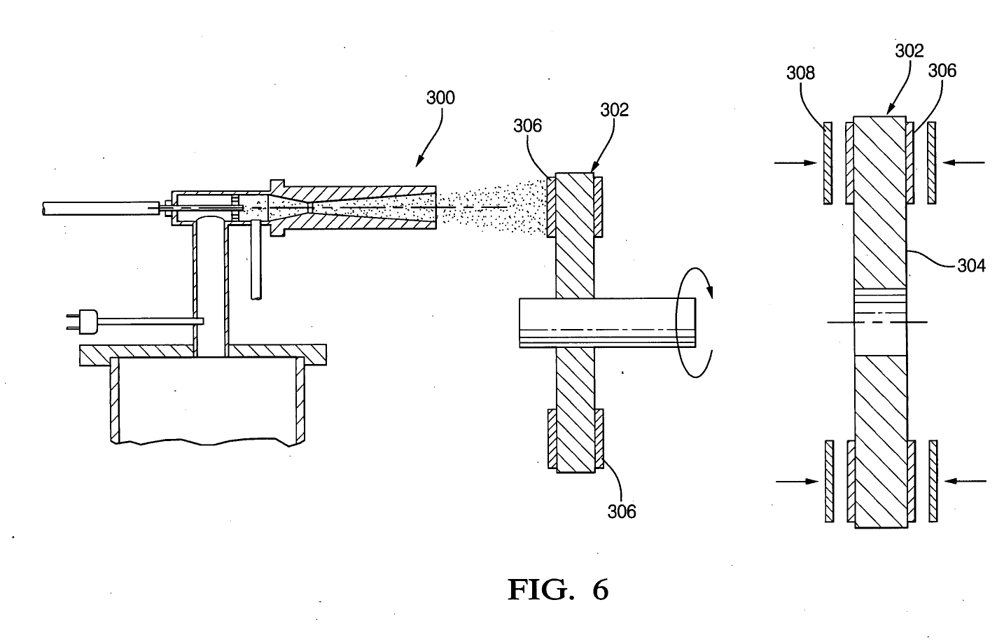

FIG. 6 illustrates an exemplary spray coating process as applied to a brake rotor, and a coated brake rotor ready for service. Any spray process may be used as long as the resultant coating performs adequately (e.g. thermal spray, kinetic spray or others). The surface area of the rotor accepting the coating and the film thickness are controlled as part of the spray process. Kinetic spray source materials are typically combined, for multi-component coatings, in a powder hopper, and then the powders are sprayed simultaneously over the substrate. The kinetic spray process is a relatively new process that uses metallic powders to rapidly deposit coatings. In the process, metallic powder particles are injected into a de-Laval type nozzle and then accelerated to high velocities by a supersonic gas stream. Upon impingement on the substrate, the powder particles are plastically deformed and form a coating through their bonding to the substrate and to one another. Detailed description of the kinetic spray process and the apparatus has been reported previously; see T. H. Van Steenkiste et al., Surface and Coating Technology, 111 (1999), p 62, herein incorporated by reference. The feedstocks for kinetic spray are solid particles that typically range from greater than 50 to 200 microns in diameter. When depositing composites, either simple mixtures blended uniformly, or agglomerations formed by ball milling, of the different species can be used as feedstock powders. During depositions, the substrate to be deposited is typically kept at a distance of 2-10 cm from the nozzle exit. The pressure of inlet gas was kept at 2.0 MPa (300 psi). The gas pressure in the powder feeder was 2.4 MPa (350 psi). The temperature of the primary gas is varied from 300 C to 650 C, depending on the feedstock powder. Generally, higher gas temperature lead to better deposition efficiency, denser coating and better adhesive strength. However, excessively high gas temperature could cause nozzle faulting such as powder buildup inside the nozzle, and nozzle clogging. During the coating deposition, the substrate is moved at a constant speed in the front of the spray nozzle. The linear translation of the substrate (referred to as the traverse speed hereafter) can be varied to alter the average thickness of the deposited coating. The other variables commonly used to control coating thickness includes federate of feedstock powders and the number of scans by the nozzle. When using kinetic spray processes, it is possible to make coatings several centimeters thick.

In a thermal spray process, multi-component compositions can be built by separately optimizing and then spraying each component from separate guns, or by spraying mixtures of the components from each gun. For example, in one process a zinc/aluminum wire and copper wire were fed through a twin wire arc thermal spray gun. In another process, two gun spray patterns are overlapped, where the first gun sprays only zinc/aluminum at about 85/15 respective percents, and the second gun sprays only copper. It will also be appreciated that cored or wrapped wire may also be considered. Other thermal processes might include powder processes incorporating powdered metal mixtures, for example.

It will be appreciated that the brake component may be cleaned by alkaline degreasing and/or wire brushing prior to coating, for example. Further, prior to coating the brake component may be heated at a temperature lower than the coating process, typically about 180 to 250 C and more preferably about 180 to 220 C, thereby improving the coating adhesiveness. An induction heater may be employed and part temperature may be determined by known methods. It should be appreciated that when heating the part, the desired temperature should be increased by about 50 to 70 C thereby accommodating a cooling period prior to coating and also accommodating natural cooling as the coating is applied. After the coating is applied, the coated component may be thermally annealed or otherwise post treated as known in the art.

### EXAMPLE 1

A rotor is coated in accordance with the present invention. The component is first wire-brushed and then alkaline rinsed followed by washing. The rotor is then preheated to about 250 C prior to coating. A composite coating including copper and zinc/aluminum is then applied to the rotor by twin arc thermal spray processing. The composite is created by using a single arc spray gun. Accordingly, a wire of zinc/aluminum and a wire of copper were fed into the gun. The composition can be varied by adjusting the wire diameter of the source materials. Similar results are expected with regard to similar compositions sprayed with separate guns, wherein each gun sprays either zinc/aluminum, or copper.

An adhesion test was performed using a Romulus IV Universal materials tester manufactured by Quad Group, Inc. To measure the coating adhesion to a substrate, an Al stud with an epoxy coating is mounted on the coating surface by some clamping mechanism. The epoxy is cured in an oven at about 150 C for about one hour. The stud is then pulled off at a controlled rate and the breaking force measured. Knowing the stud size, the adhesion strength of the coating may be determined. Pull test adhesive strength of the zinc/aluminum alloy coating over the machined cast iron rotor surface has been demonstrated to be about 7 kpsi.

### EXAMPLE 2

A rotor is coated in accordance with the present invention. The component is first wire-brushed and then alkaline rinsed followed by washing. The rotor is then preheated to about 250 C prior to coating. A composite coating including 420 stainless steel and zinc/aluminum alloy is then applied to the rotor by twin arc thermal spray processing. The composite is created by using a single arc spray gun. Accordingly, a wire of zinc/aluminum and a wire of 420 stainless steel were fed into the gun. The composition can be varied by adjusting the wire diameter of the source materials. Similar results are expected with regard to similar compositions sprayed with separate guns, wherein each gun sprays either zinc/aluminum, or 420 stainless steel. An adhesion test was performed as defined in Example 1. Pull test adhesive strength of the matrix zinc/aluminum alloy matrix over the machined cast iron rotor surface has been demonstrated to be about 7 kpsi.

### EXAMPLE 3-COMPARATIVE EXAMPLE

A rotor containing a zinc corrosion resistant coating was evaluated with regard to sliding engagement with a standard brake lining. The coating was found to exhibit galling and the build-up of asperities over the wear surface that interfered with the braking action. The asperities induced unwanted vibration and audible noise from the associated braking system. Furthermore, the asperities eroded the surface of the brake lining or brake shoes as the number of revolutions of the rotor past the stationary lining increased.

### EXAMPLE 4

A brake component surface was coated in accordance with the present invention, with the majority of the coating containing the sacrificial corrosion component. The component was tested for 300 hours of ASTM B117 salt spray testing and showed less than 10% of the base cast iron with red rust.

### EXAMPLE 5

A conventional disc brake rotor coated using 2 mm OD Zinc/Aluminum (e.g. 85/15 Zn/Al alloy) and 1.1-1.6 mm OD Copper indicated no asperity formation after a combined 40 stops of light (5 to zero MPH) and heavy (60 to zero MPH) brake applications; rotor/lining material transfer was inhibited thereby keeping the lining clean. After 168 hours of the DCM 5157 humidity test, little or no rust occurred.

### EXAMPLE 6

A conventional disc brake rotor coated using 2 mm OD Zn—Al (85/15) and 1.1-1.6 mm OD 420 Stainless Steel indicated no asperity formation after a number of stops as defined in Example 5; rotor/lining material transfer was inhibited thereby keeping the lining clean. After 168 hours of the DCM 5157 humidity test, little or no rust occurred. The coating remained adherent up to about 5 kpsi, as measured by the pull strength adhesion test.

### EXAMPLE 7-COMPARATIVE EXAMPLE

A brake rotor identical to Example 4 was coated with corrosion resistant paint in a known manner. The coating only remained adherent up to about 700 psi, as measured by the pull strength adhesion test defined in Example 1. It will be appreciated that with regard to adhesiveness, coatings of the present invention preferably exhibit a pull strength of 3 kpsi or more.

### EXAMPLE 8

A 1.0 mil thick composite coating of zinc/aluminum alloy and copper coating failed after 24 hours of B117 salt spray exposure. This coating contained about 40% of elemental copper. This indicates that there was an insufficient amount of sacrificial material to maintain longer-term corrosion resistance. The coating did exhibit asperity-free braking surfaces when tested on vehicle using standard linings. This example illustrates that having too much hard material in the coating, at the expense of the sacrificial corrosion resistant constituent or matrix diminishes the corrosion resistance while retaining an asperity interference mechanism. When compared to examples 5 and 6, it is apparent that each application must be evaluated with regard to the substrate being coated and to conditions existent in the surrounding environment, and then the proper coating composition and depth must be iteratively determined with regard to adhesion, wear resistance, corrosion resistance, and coefficients of friction of the substrate and the coating. This testing may be readily accomplished pursuant to known laboratory procedures and by one of ordinary skill in the art.

It has been found that with regard to coating thickness or depth, the first consideration with regard to the sacrificial corrosion constituent is the corrosion resistance as determined by the ASTM B117 salt corrosion exposure test. To survive about 300 hours of corrosion resistance with a ZnAl (85/15) coating, a thickness of about 0.8 mil is needed. With a Zn coating, a thickness of about 2 mil is needed. As the relative proportion of the hard constituent is added and increased, the thickness of the coating must be increased to maintain corrosion resistance. For instance, a ZnAl/420SS coating (31.6% 420SS) requires a 1.5 mil thickness to last 300 hours. A ZnAl/Cu, 21 wt % Cu composition requires a 2 mil thickness to last 300 hours. The second consideration is wear resistance. The time the coating should last, as forces causing wear are exerted thereon, and the time that corrosion resistance is needed would determine on an iterative basis the coating thickness required for that application. In general then, the coating may be provided in various thicknesses depending on the variables identified above. A preferred thickness of the coating ranges from about 0.5 mil to about 3.0 mil.

### EXAMPLE 9

### Thermal Spray of Zinc/Aluminum (ZnAl)

A rotor was coated using a first wire of ZnAl (2 mm) and a second wire of ZnAl (2 mm). A TAFA 8835 Twin Wire Arc Gun was employed and mounted on a robotic arm, utilizing 23V and 90-140A. Wire feed was about 650-1000 (corresponding to 1.65-2.54 g/s of ZnAl wire). Traverse speed was 5-15 mm/s. Atomization pressure was 135 psi and cooling air was off. The rotor was mounted on a rotary stage rotating at 100 RPM, the stage having a rotary range of 10-200 RPM. The stand off was 150 mm (6 inches).

### EXAMPLE 10

### Thermal Spray of ZnAl/Cu

A rotor was coated using the same equipment configuration of Example 9, and a first wire of ZnAl (2 mm) (−ve electrode) and a second wire of Cu (1.1-1.6 mm) (+ve electrode). For Cu wire having a 1.1 mm diameter, 32V and 120A were utilized, with a wire feed of 800 and a traverse speed of 10 mm/s for a 1 mil thick coating. For Cu wire having a 1.6 mm diameter, 31V and 170A were utilized, with a wire feed of 800 and a traverse speed of 10 mm/s for a 1.5 mil thick coating. The RPM for the rotary stage was 100 RPM. The stand off was 150 mm.

### EXAMPLE 11

### Thermal Spray of ZnAl/420SS

A rotor was coated using the same equipment configuration of Example 9, and a first wire of ZnAl (2 mm) (−ve electrode) and a second wire of 420SS (1.1 mm-1.4 mm-1.6 mm) (+ve electrode). For 420SS wire having a 1.1 mm diameter, 31-32V and 120A were utilized, with a wire feed of 800 and a traverse speed of 5 mm/s for a 1 mil thick coating. SS content was about 20 wt %. For 420SS wire having a 1.4 mm diameter, 31-32V and 120A were utilized, with a wire feed of 800 and a traverse speed of 3 mm/s for a 1.25 mil thick coating. SS content was about 30 wt %. For 420SS wire having a 1.6 mm diameter, 31V and 170A were utilized, with a wire feed of 600 and a traverse speed of 6 mm/s for a 0.7-0.8 mil thick coating. SS content was about 40 wt %. The RPM for the rotary stage was 100 RPM. The stand off was 150 mm.

### EXAMPLE 12

### Thermal Spray of ZnAl/Brass

A rotor was coated using the same equipment configuration of Example 9, and a first wire of ZnAl (2 mm) (−ve electrode) and a second wire of Brass (1.6 mm) (+ve electrode). For Brass wire having a 1.6 mm diameter, 30V and 130A were utilized, with a wire feed of 800 and a traverse speed of 12 mm/s for a 1.2 mil thick coating. The RPM for the rotary stage was 100 RPM. The stand off was 150 mm.

### EXAMPLE 13

### Thermal Spray of ZnAl/SiBronze

A rotor was coated using the same equipment configuration of Example 9, and a first wire of ZnAl (2 mm) (−ve electrode) and a second wire of SiBronze (1.6 mm) (+ve electrode). For SiBronze wire having a 1.6 mm diameter, 32V and 140A were utilized, with a wire feed of 800 and a traverse speed of 10 mm/s for a 1.3-1.5 mil thick coating. The RPM for the rotary stage was 100 RPM. The stand off was 150 mm.

### EXAMPLE 14

### Thermal Spray of Al/420SS

A rotor was coated using the same equipment configuration of Example 9, and a first wire of Al (2 mm) (−ve electrode) and a second wire of 420SS (1.6 mm) (+ve electrode). For 420SS wire having a 1.6 mm diameter, 35V and 140A were utilized, with a wire feed of 800 and a traverse speed of 12 mm/s for a 1.2 mil thick coating. The RPM for the rotary stage was 100 RPM. The stand off was 150 mm.

### EXAMPLE 15

### Determination of Torque Output and Related Coating Coefficient of Friction

The “Green” (period of initial lining to coating contact and interaction, where dynamometer measured output torque may vary) and “Burnish” (period where lining to coating interaction and the output torque has stabilized) sections of the GMN 5228 test are evaluated in known testing procedures. After 10 stops of the Green test portion, the coated rotors preferably exhibit a consistent (within +/−15% of the Burnished Nominal Coefficient of Friction), reproducible braking torque as measured on a dynamometer. After these 10 stops, the apparent friction coefficient is preferably greater than about 0.32. Stated another way, after burnishing the rotors, i.e. when output torque has stabilized, the apparent friction coefficient is preferably greater than 0.32. Additionally, in a preferred embodiment, braking torque may smoothly transition to that of cast iron as the coating wears away.

In general, the degree of adhesion of the coating to the base material is believed to be dependent upon the type and the amount of hard material in the coating. Additionally, braking surfaces are relatively smooth. This is counter to typical preference for roughened surfaces accepting thermal spray coatings. It has been found that the higher melting point materials (stainless steels) adhere poorly to the smooth cast iron base, or at least under particular spray conditions. Adhesion of the lower melting point materials was satisfactory for an automotive environment.

Thermal spray coatings are in general applied as a thin layer (coating) over an established surface. This is primarily due to the fact that residual stress, induced in the coating from the liquid to solid phase change, strictly limits the attainable coating thickness. Thermal spray technology has been used to create various brake coatings [7]. The kinetic spray technique doesn't suffer from this limitation, as the kinetic spray particle's temperatures are well below their melting temperature throughout the spray process.

The coating performance of zinc, aluminum, and their alloys, or other sacrificially corroding materials (with respect to the base rotor material) may be positively influenced through application to the substrate under conditions of elevated substrate temperatures. That such temperatures may initiate a metallurgical reaction with the substrate (e.g. galvanizing in the case of cast iron base material), or may simply promote adhesion, is known to those familiar with the art of coating deposition. Also, low melting point material such as zinc may flow at these higher temperatures, resulting in a reduced coating porosity.

Once the coating is applied by kinetic spray, thermal spray, or both (or by another coating technique), post-coating processing may prove beneficial. Post-coating heat treatment may insure the coating or coatings indicate improved bonding (adhesion) to the rotor surface, improved cohesion within the coating, exhibit a desired porosity, or possibly alloy to produce beneficial coating performance. Such additional processes may include a global or surface heat treat procedure (such as induction or laser heating). Heat treatments may be used to anneal, form a diffusional bond, diffuse the coating material into the substrate, or even instigate interfacial coating/substrate intermelting (galvanizing). Heating can be used to chemically alter the deposited material's composition as well. Additionally, a topical infusion of yet another material over the coating may be used to impart addition corrosion resistance by making the coating impermeable to corrosive agents. A thermal annealing process might also be used to make the coating impermeable to corrosive agents and to improve coating adhesion and porosity characteristics (especially as the melting temperatures of aluminum and copper are well below that of the cast iron rotor). Additionally, cold working of the coating upon the substrate might also prove beneficial.

Once the coating is formed, it may be necessary to burnish, bead blast, mechanically turn (cut), or grind the coating's surface to achieve a certain specified surface finish. Depending upon the coating, a SiC, diamond, or other grinding wheel composition could be used to achieve a desired degree of coating smoothness.

Coating porosity could vary with depth from surface to substrate. For example, porosity could be made nearly nonexistent near the substrate, acting as an impermeable membrane to aqueous corrosive agents. Porosity at the braking surface could be made purposely finite to form a more suitable couple with the brake pad material (pores may desirably retain lubricious brake pad material).

Many material deposition techniques, including kinetic and thermal spray processes can be integrated into manufacturing lines to coat parts in a rapid and economical manner. The mentioned spray techniques are environmentally benign, as they do not impart contamination to the water or air.

Additionally, it may be possible to add zinc or other suitable material to the cast iron melt at low concentrations then subsequently be solidified within the cast iron. This interstitial/substitutional impurity would be expected to migrate to the cast iron surface during each significant rise of brake rotor temperature (as would be the case with a brake pad application) due to surface energy considerations. Zinc can be made in this manner to constantly refresh that which is lost due to rotor surface wear. Such a zinc-rich surface may offer corrosion resistant behavior, with a minimum influence upon the base cast iron frictional characteristics, for the lifetime of the rotor.

All metals are provided either in rod or powder form by well known suppliers. All kinetic and thermal spray equipment is also provided by well known suppliers. Wire suppliers of various metals and alloys are supplied, for example, by TAFA Incorporated of Concord, N.H. Powder suppliers of metals and alloys are supplied, for example, by ATLANTIC EQUIPMENT ENGINEERS of Bergenfield, N.J., and, by CEAC of Sandy Hook, Conn. Twin Wire Arc Spray equipment suppliers include Praxair, Inc. of Danbury, Conn., and, Sulzer Metco (US) Inc., of Westbury, N.Y. Kinetic Spray equipment suppliers include Flame-Spray Industries, Inc. of Port Washington, N.Y.

In yet another aspect of the invention, a method of manufacturing a metallic component containing the following steps, and a metallic component formed thereby, is presented. A stream of particles formed from a sacrificial corrosion constituent as described above is provided as described above. A stream of particles formed from a second constituent as described above is also provided. Each stream, either separately or combined together, depending on the coating method employed, is then directed to coat the metallic component, whereby a coating is selectively applied to surfaces prone to corrosion, and more particularly to those surfaces also requiring wear resistance. As described above, it should be emphasized that the second constituent is relatively harder than the first constituent, and the sacrificial corrosion constituent has a more negative electrode potential than the metal component. The metal component may be automotive in nature, or, it may have aeronautic, maritime, or other application.

While specific embodiments of the instant invention have been described in detail, those with ordinary skill in the art will appreciate that various modifications and alternatives to those details could be developed in light of the overall teachings of this disclosure. Accordingly, the particular arrangements disclosed are meant to be illustrative only and not limiting as to the scope of the invention, which is to be given the full breadth of the appended claims and any and all equivalents thereof.

We claim:

1. A brake assembly comprising:
a first component constructed of a metal;
at least one surface on said first component; and
a coating applied to said at least one surface wherein said coating comprises a sacrificial corrosion constituent and at least one second constituent relatively harder than the first constituent, said sacrificial corrosion constituent having a more negative electrode potential than said first component, and, said at least one second constituent selected from carbides, oxides, nitrides, diamonds, transitional metals and alloys thereof, quasicrystal materials, and mixtures thereof.

2. The brake assembly of claim 1 wherein said at least one surface is a wear surface.

3. The brake assembly of claim 1 wherein said carbides are selected from silicon carbide, tungsten carbide, chromium carbide, and boron carbide.

4. The brake assembly of claim 1 wherein said nitrides are selected from silicon nitride, boron nitride, chromium nitride, and titanium nitride.

5. The brake assembly of claim 1 wherein said oxides are selected from aluminum oxide, chromium oxide, iron oxide, and titanium dioxide.

6. The brake assembly of claim 1 wherein said sacrificial corrosion constituent is selected from zinc, aluminum, magnesium, mixtures thereof, and alloys thereof.

7. The brake assembly of claim 1 wherein the coating exhibits an adhesion strength pull test rating of at least 3000 psi.

8. The brake assembly of claim 1 wherein the coating contains about 30 to 90% by weight of the sacrificial corrosion constituent, and about 10 to 70% by weight of the second constituent.

9. A coating composition for a metal substrate, said coating comprising:
a sacrificial corrosion constituent; and
at least one second constituent selected from carbides, oxides, nitrides, diamond, transitional metals and alloys thereof, and mixtures thereof,
wherein said second constituent is relatively harder than said first constituent, and said sacrificial corrosion constituent has a more negative electrode potential than said metal substrate.

10. The coating of claim 11 wherein said carbides are selected from silicon carbide, chromium carbide, tungsten carbide, and boron carbide.

11. The coating of claim 11 wherein said nitrides are selected from silicon nitride, boron nitride, chromium nitride, and titanium nitride.

12. The coating of claim 11 wherein said oxides are selected from aluminum oxide, chromium oxide, iron oxide, and titanium dioxide.

13. The coating of claim 11 wherein said sacrificial corrosion constituent is selected from zinc, aluminum, magnesium, mixtures thereof, and alloys thereof.

14. The coating of claim 11 containing about 30 to 90% by weight of the sacrificial corrosion constituent, and containing about 10 to 70% by weight of the second constituent.

15. A method of manufacturing a metallic component having a wear surface, the method containing the steps of:
providing a stream of particles formed from a sacrificial corrosion constituent;
providing a stream of particles formed from a second constituent; and
directing the stream of particles formed from the sacrificial corrosion constituent and the stream of particles formed from the second constituent to coat the wear surface of the metallic component,
wherein the second constituent is relatively harder than said first constituent, and said sacrificial corrosion constituent has a more negative electrode potential than said metal substrate.

16. A brake assembly formed by the method of claim 15.

17. The method of claim 15 further comprising the step of providing pre-process treatment to tailor the adhesion and wear properties.

18. The method of claim 15 further comprising the step of providing post-process treatment to tailor the adhesion and wear properties.
